(19) United States
(12) Patent Application Publication
(10) Pub. No.: US 2025/0042497 A1
(43) Pub. Date: Feb. 6, 2025

(54) COLLISION AVOIDANCE USING A VEHICLE PROXIMITY APPARATUS AND ALERT SYSTEM

(71) Applicant: HEDS UP SAFETY INC., Haliburton (CA)

(72) Inventors: Stephen Paul CHURKO, Guilford (CA); Rachel Kellie CHURKO, Guilford (CA); Jason Tyler GRIFFIN, Kitchener (CA); Joshua Kwan Ho WONG, Waterloo (CA); Timothy MACKAY, Gatineau (CA); Thai NGUYEN, Georgetown (CA); Minxuan WANG, Milton (CA); Benjamin ALTMAN, Mississauga (CA); Lawrence Sze-Heen LEUNG, North York (CA)

(21) Appl. No.: 18/764,569

(22) Filed: Jul. 5, 2024

Related U.S. Application Data
(60) Provisional application No. 63/512,056, filed on Jul. 5, 2023.

(51) Int. Cl. B62J 50/22; B62J 45/41

(52) U.S. Cl. CPC B62J 50/22; B62J 45/41

(57) ABSTRACT

A vehicle proximity and alert system and apparatus warns snowmobilers of other approaching vehicles with potential risk of collision. To better prevent accidents, the system calculates collision risks and warns the rider based on level of risk. When riding in groups, a member can press a stop request button to ask the group to slow down. When a member exits the group, everyone in the group will receive a message, alerts or indication with the update. The vehicle detection system utilizes Bluetooth low energy (BLE), LoRa technologies and/or global positioning system technologies and is designed to detect other devices in the region and use acquired information to calculate proximity and risk of collision.

### CROSS-REFERENCE TO RELATED APPLICATIONS

This application claims the benefit of U.S. Provisional Patent Application No. 63/512,056 filed Jul. 5, 2023. The entire contents of U.S. Provisional Patent Application No. 63/512,056 is hereby incorporated by reference, for all purposes.

### BACKGROUND

The embodiments described herein relate to the field of collision avoidance systems and more specifically to proximity sensor and alert systems particularly for use with snowmobiles and other off-road vehicles.

Snowmobiles and all-terrain vehicles (ATVs) are motorized off-road vehicles that operate on snow, ice and dirt roads, and as well as on open terrain or trails. As a result of their inherent maneuverability, acceleration, and high-speed abilities, skill and physical strength are typically both required to safely operate a snowmobile or other off-road vehicle. Losing control of a snowmobile or off-road vehicle can easily result in serious damage, injury and even death. One such cause of loss of control is due to a collision with an obstruction. FIG. 1 is a diagram illustrating a snowmobile accident.

For example, many snowmobile-related deaths occur when drivers collide with trees, trail groomers, and other snowmobiles. The hazard level for snowmobile riders is particularly high as due to the high-speed abilities of snowmobiles and limited visibility on trails, the amount of time to react to obstructions is reduced.

Snowmobiles and other off-road vehicles such as all-terrain vehicles (ATVs) exhibit a safety problem whereby riders may be injured and possibly killed in accidents during rides. Snowmobilers often struggle to receive timely warnings of other riders that are present and are at risk of colliding with them. This is especially dangerous at high speeds when riding over a hill and when turning a sharp blind corner with limited visibility. Furthermore, there is generally no warning for areas with limited visibility and there are dangers of colliding with other snowmobiles while riding at high speed.

Furthermore, when multiple off-road vehicles are riding as a group, there is a visibility problem in that there is often no visibility of one's own group members when riding. Specifically, there is no visibility of members in your own group and no way of letting the leader know that they are riding too fast. Typically, the leader (i.e., the leading vehicle in a group) has no way of knowing when a group member located behind them is falling behind or in distress. Often, the group would have to stop at the next stop or check point to wait for someone to catch up. Contact with the rest of the group can be made even more challenging with limited cellular reception that is typical in some remote areas where off-road vehicles are used. There is a desire for a reliable collision avoidance system for off road vehicles (e.g., snowmobile and all-terrain vehicles) to help avoid the above-mentioned problems

### SUMMARY

According to some embodiments, a vehicle proximity and alert system and apparatus warns snowmobilers of other approaching vehicles about a potential risk of collision. To better prevent accidents, the system calculates collision risks and warns one or more riders based on a level of risk. When riding in groups, a member can press a stop or slow request button to ask the group to stop or slow down.

When a member exits the group, one or more members of (or everyone in) the group will receive a message, alert(s) or indication with the update for the exiting member.

The vehicle detection system utilizes different communication technologies, including for example Bluetooth low energy (BLE), LoRaWAN (i.e., LoRa) technologies and/or global positioning system technologies. The vehicle detection system may be designed to detect other devices in the region and use acquired information about those other vehicles to calculate proximity of those vehicles and/or risks of collision.

### BRIEF DESCRIPTION OF THE DRAWINGS

Several embodiments will be described in detail with reference to the drawings, in which:

FIG. 1A is a diagram illustrating a snowmobile accident.

FIG. 1B is a diagram illustrating a snowmobile with an exemplary vehicle proximity and alert apparatus.

FIGS. 2A to 2C are diagrams illustrating an exemplary vehicle proximity and alert apparatus.

FIG. 3 is a diagram illustrating a power on/off workflow.

FIG. 4A is a diagram illustrating a group formation workflow for members.

FIG. 4B is a diagram illustrating a group formation workflow for leaders.

FIG. 5 is a diagram illustrating reopening existing group workflow.

FIG. 6 is a diagram illustrating dynamic grouping workflow.

FIG. 7 is a diagram illustrating workflow for stop/help calls.

FIG. 8 is a diagram illustrating collision warning workflow.

FIG. 9A is a perspective view of prototype and mass production unit.

FIG. 9B is a table of the dimensions of prototype and mass production unit.

FIG. 10 is a perspective view of the USB port cut-out of a prototype and mass production unit.

FIGS. 11A and 11B are perspective views of the mounting interface for a prototype and mass production unit.

FIGS. 12A to 12D are diagrams illustrating different screens on the vehicle proximity and alert apparatus.

FIGS. 13A to 13D are diagrams illustrating different grouped screens on the vehicle proximity and alert apparatus.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DETAILED DESCRIPTION

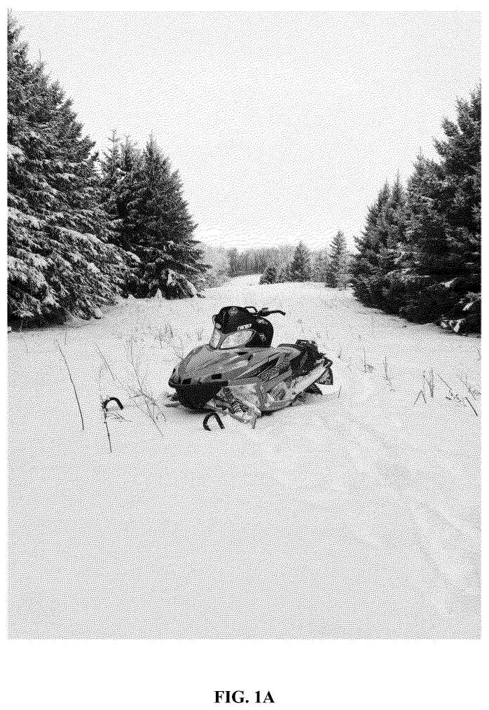

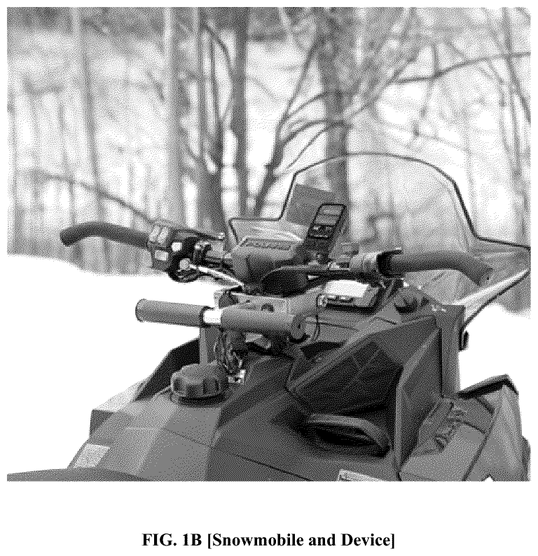

According to embodiments of this disclosure, a vehicle detection system is disclosed that aims to help prevent vehicle collisions of off-road vehicles such as snowmobiles and all-terrain vehicles (ATVs). The vehicle detection system may allow visibility into other riders in the surrounding environment, as well as those within their group. FIG. 1B is a diagram illustrating a snowmobile with an exemplary vehicle proximity and alert apparatus according to one embodiment.

### Objectives:

According to aspects of this disclosure, a vehicle detection system for snowmobiles is disclosed as a collision prevention warning system, in which one or more of the following objectives may be desired:
Snowmobile riders will carry or have a device with Bluetooth/LoRa chip or global positioning system (GPS).
Device may warn users based on distance (and/or relative speed) of other devices detected (in some embodiments, devices may establish a mesh network when two or more devices approach each other, and in some cases there may be auto-adjustment of the network once one or more devices moves out of range).
The system and device may be able to give enough warning to users given reasonable reaction time (which could be based on factors such as vehicle speed).
In some cases, the device and system may use LoRa for detection (which may provided for increased range) and which may be used for device-to-device communication. In some cases, this may mitigate latency (i.e., caused by advertisement/handshake/info exchange, etc.).
In some cases, the system may warn users of oncoming vehicles from one or more (or even all) directions.
In some cases, a device may be able to reliably detect other devices over hills, around corners, and in obstructed environments (i.e., lots of trees and vegetation) using radio communication, which could include a device-to-device network or Bluetooth mesh network.
In some cases, the devices may be designed to operate in snow, ice, rain, mud and extreme environments, including extreme temperatures (i.e., snow and cold).

### Group Pairing Features:

According to some aspects of this disclosure, in some embodiments a vehicle detection system may have group pairing features, including one or more of the following aspects that may be desirable:

### Vehicle Approaching Scenarios

In some cases, the system may explore an ability to assess directionality (i.e., of approaching vehicles).
In some cases, the system may include one or more (i.e. two) directional or multi-directional lights, light flashes and/or other alerts as one or more other vehicles approach.
In some cases, the system may include one or more lines of LEDs, such as lights that turn red as another vehicle approaches closer and closer, an may include one or more of line and ring LED configurations.

### Members in Range

In some cases, the system may use LEDs to indicate number of members within a group.
In some cases, the system may include associating and/or pairing devices at the beginning of the ride to add riders to a group.
In some cases, once riders are added to a group, the system may monitor the riders, and may note when riders drop in and out of range (i.e., when members leave the group and/or when riders re-join the group).
In some cases, the system could offer insights, assurances, and/or opportunities for communication within a group of riders that are otherwise unknown.

### Members in Range

In some cases, the system may allow one or more riders to send messages to other members of the group (i.e., send a “Stop” or “Slow”) notification to group members as they come in range.
In some cases, the system may include an option to send a “Stop” request when needed to group members that are within range.
In some cases, the system may allow for slower or rear riders to let those ahead of them know of need for a stop or to adjust the speed of the group.

### LoRa Integration

In some cases, the system might mitigate detection latency and delivering warnings to user with sufficient reaction time to prepare for potential collision.
In some cases, the system might adjust the number or members (i.e., increase to more members) within range when SOS signal is sent in case of emergency.
In some cases, when an SOS button or alarm is pressed, a general signal beacon may be sent to any device within range independent of their grouping status. This can allow SOS alerts to be sent to other devices not associated with the particular group.
In some cases, the system may allow group members to move further away without losing pairing connection. For instance, group members may be out of communications proximity with the other members of the group, but may stay paired as members of the group.
In some cases, LoRa may be is ideally suited for long range communication (0-20 km+), while using low power asset tracking (i.e., approx. 4-8 hours of battery life using 2AAs).

### Hardware:

According to some aspects of this disclosure, in some embodiments, hardware for use with some exemplary systems might include the following:
LED warning/direction lights
Buttons (Power, Reset, SOS, Stop Request)
Main printed circuit board (PCB) & antenna
Communication Technology (Bluetooth and LoRa)
Gyroscope
Global positioning system (GPS)
Accelerometer
Magnetometer
Lidar (optional)
Charging: (i.e., USB-C, etc.)
Firmware Updates (i.e., wireless, over USB, etc.): over USB
One or more batteries (which could include replaceable and non-replaceable options). In some cases, a battery could include one or two lithium thionyl chloride (Li SOCL2) batteries, which may be particularly suitable to withstand harsh temperatures. In some other cases, a battery could include prismatic batteries (for example a prismatic batter having the following dimensions: 37 mm×50 mm×8 mm may provide approximately 2500mAh of power).

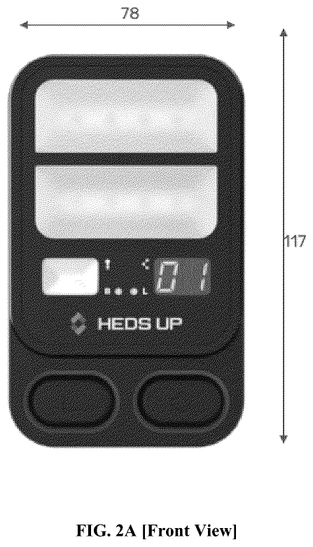

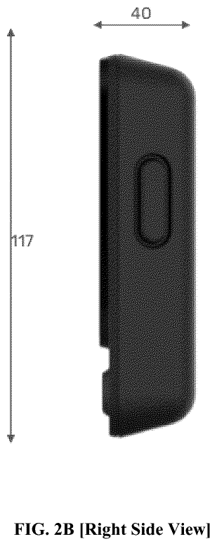

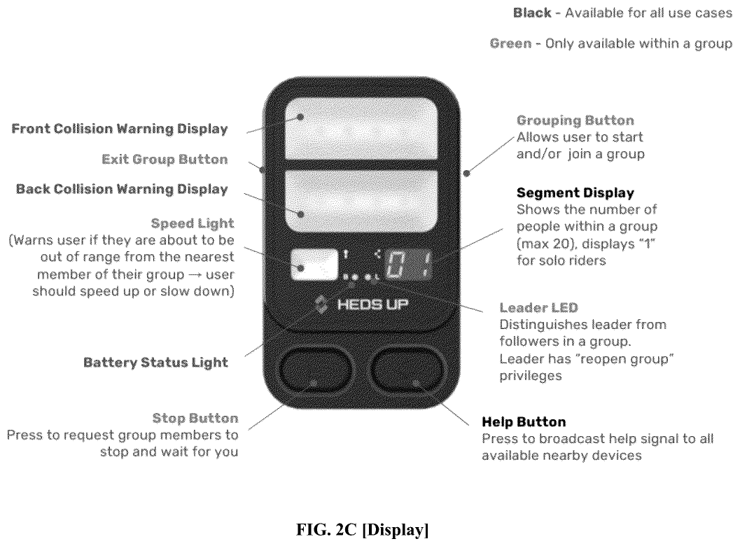

FIGS. 2A to 2C are diagrams illustrating an exemplary vehicle proximity and alert apparatus. FIG. 2A illustrates a front plan view of an exemplary vehicle proximity and alert apparatus. FIG. 2B illustrates a right-side view of the exemplary vehicle proximity and alert apparatus. According to FIGS. 2A and 2B, in one example the front panel or display of an exemplary vehicle proximity and alert apparatus has dimensions of 78 mm width by 117 mm length by 40 mm depth.

FIG. 2C illustrates a front plan view of the display of the exemplary vehicle proximity and alert apparatus. According to FIG. 2C, the front plan view of the display may include one or more of the following display components:
Front Collision Warning Display
Back Collision Warning Display
Exit Group Button
Speed Light—this warns the user if they are about to be out of range from the nearest member of their group whereby the user should speed up or slow down
Battery Status Light
Grouping Button—allows users to start and/or join a group
Segment Display—shows the number of people within a group (max 20), displays “1” for solo riders
Leader LED—distinguishes leader from followers in a group, leader has “reopen group” privileges
Stop Button—press to request group members to stop and wait for you
Help Button—press to broadcast help signal to all available nearby devices

According to FIG. 2C, in some cases all the buttons may be available to all use cases. Furthermore, the in some cases the exit group button, speed light, grouping button, leader LED and stop may only be available within a group setting (or group rides) or during certain other configurations.

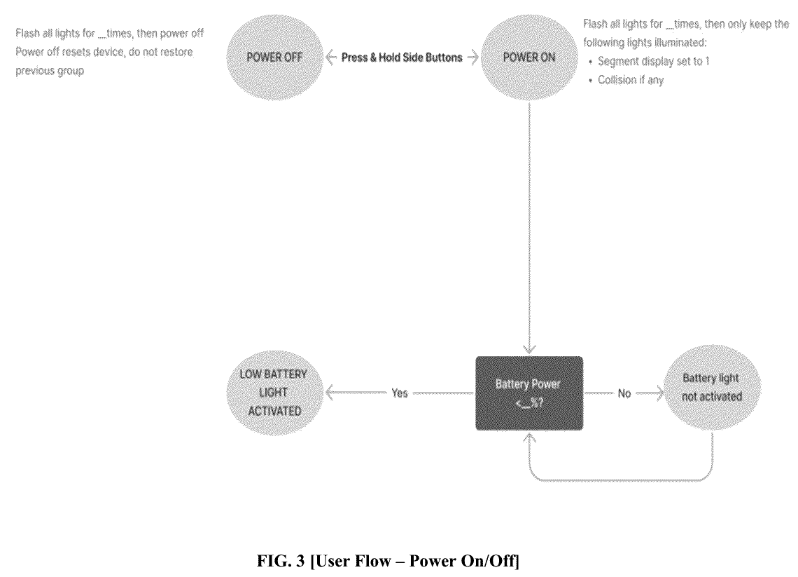

Turning now to FIG. 3, shown therein is a diagram illustrating a power on/off workflow. According to FIG. 3, when the user presses & hold the side button of the device, “Power Off” and “Power On” actions are executed. When executing a “Power Off” function, one or more (or all) lights may be flashed one or more (i.e., multiple) times, then the device can power off. In some cases, powering off resets the apparatus and may not restore the previous group.

As shown in FIG. 3, when “Power On” is selected, the device may also flash one or more (or all) lights one or more (i.e., multiple) times. After which, the device may only keep the light illuminated to segment display set to 1 and collision is any display segment. Next, in some cases the workflow may check the battery power percentage. If low battery is detected, a low battery light may be activated. If no low battery is detected, then the battery light is typically not activated. In some cases the workflow may continually check the battery percentage, for example every few minutes and so on.

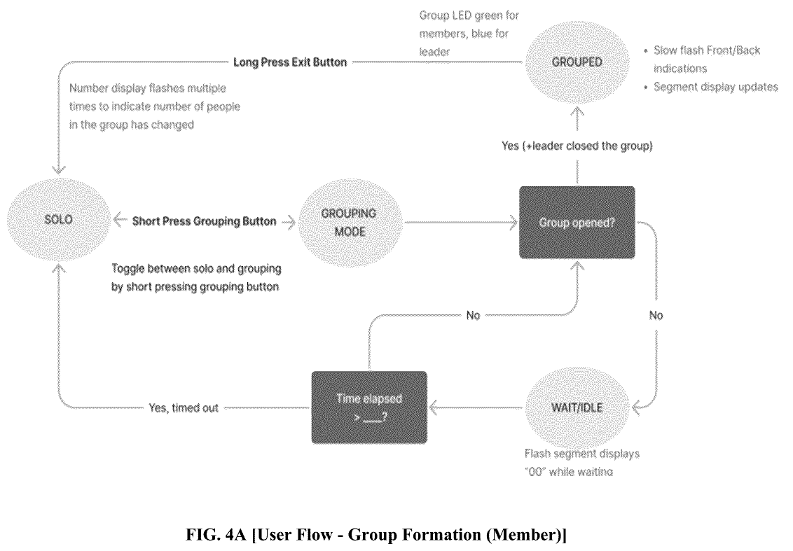

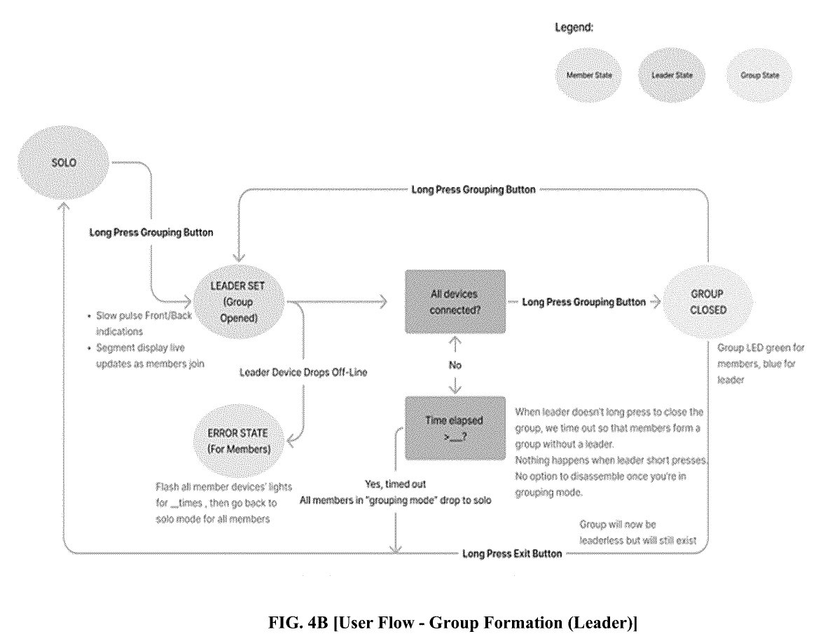

Turning now to FIG. 4A, shown there is a diagram illustrating a group formation workflow for members. According to FIG. 4A, a short press on the “grouping button” can toggle between “Solo mode” and “Grouping mode”.

When in “Grouping mode”, the workflow can determine whether the particular group is open. If Yes and/or if the leader closed the group, the workflow moves to “Grouped”. In some cases, the device may then slow flash the front and back indicators and the segment display updates. Thereafter, the group LED can turn one color for most members of the group (i.e., green) and may turn a different color (i.e., blue) for the leader.

In some cases, a long press of the exit button may toggle from “Grouped” to “Solo” mode. When the long press exit button is selected, the number display may flash one or more (i.e., multiple) times to indicate that the number of people in the group has changed.

According to FIG. 4A, if a group is not opened, the workflow can moves to the Wait/Idle state (during which the device flash segment may display “00” while waiting). Thereafter, the workflow may check on the amount of time elapsed for a timeout. If no timeout event is detected, then the workflow may returns to the “Group Opened” state. If a time out event is detected, then in some cases the workflow may toggle the mode back to “Solo” mode.

Turning now to FIG. 4B, shown therein is a diagram illustrating a group formation workflow for leaders. According to FIG. 4B, the workflow can start in “Solo” mode. A long press of the “grouping button” can place the state to “Group Opened”. The long press is typically activated or set by the leader. On the device, a slow pulse may be displayed by the front/back indications and the segment may display live updates as members join.

In some embodiments, according to FIG. 4B, if the leader device drops off-line, an error state may displayed and provided to the other group members. Furthermore, in some cases the device may flashes on one or more (or all) member device lights for one or more times, after which the member devices may revert back to solo mode for all members (although in some embodiments, a new leader may be appointed and/or one or more leaders may be prompted to become the new leader).

As shown in FIG. 4B, once the leader setting for a group opened, the next step is to determine whether all member devices are connected. If yes (all member devices are connected), a long press of the grouping button can toggle the state to “Group Closed”.

Once the “Group Closed” even occurs, in some cases the group LED may be set to green for members and blue for the leader. A further long press of the grouping button may be used to return the state to “Group Opened”. Furthermore, a long press of the exit button may be used to revert the state back to “Solo” mode whereby the group to be leaderless (but nevertheless may still exist).

In some cases, according to FIG. 4B, if all devices are not connected, the workflow may check whether a timeout occurs (i.e., certain amount of time has elapsed). If a timeout is detected, all members in “Grouping mode” may drop back to “Solo” mode. Furthermore, in some cases when the leader does not close the group (i.e., by long pressing the grouping button), there may be a timeout so that members can form a group without the leader. In some cases, nothing may happen when the leader completes short presses and there may be no option to disassemble once members are in grouping mode.

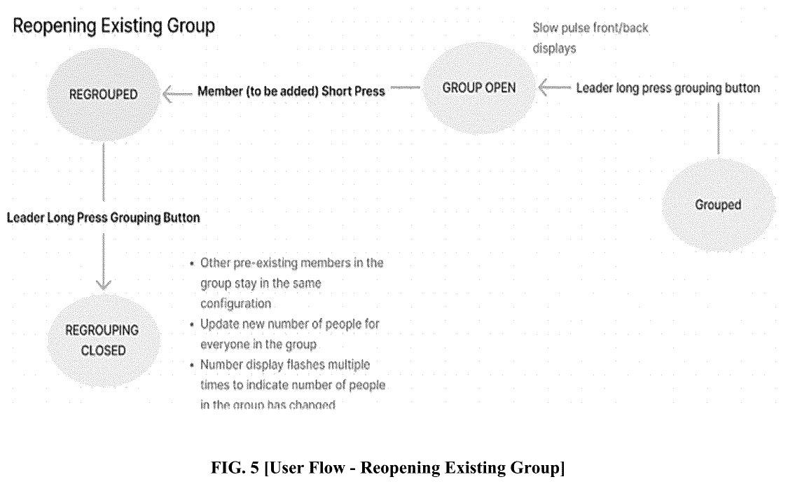

Turning now to FIG. 5, shown therein is a diagram illustrating reopening an existing group workflow. According to FIG. 5, the workflow for reopening an existing group may be initiated by having the state in “Grouped” mode. The leader may then long press the grouping button to place the state to “Group Open”. A slow pulse of the front and back display may be shown on the device.

In some cases, once in “Group Open” state, the new members or members to be added may short press the grouping button, which placed the state to “Regrouped”. Next, the leader can long presses the grouping button to place the state to “Regrouping Closed”.

In some cases, as shown in FIG. 5, the re-opening existing group workflow may further enable one or more of the following functions:
other pre-existing members in the same group stay in the same configuration
update new members of people for everyone in the group
display flashes one or more (i.e. multiple) times to indicate number of people in the group has changed

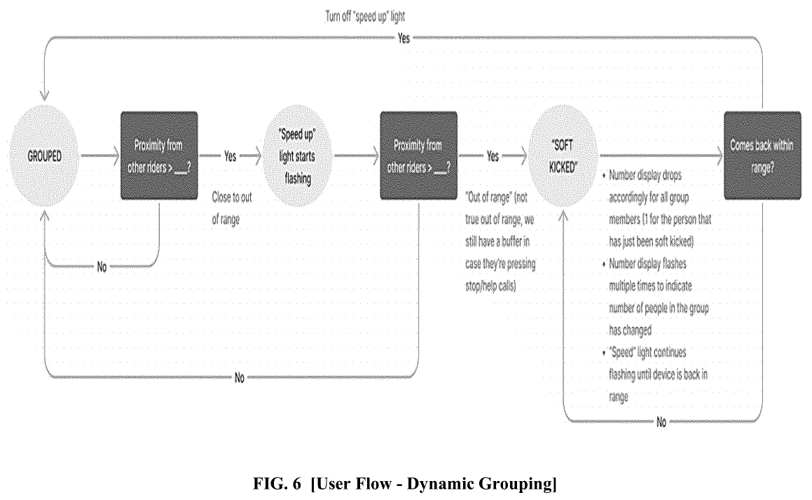

Turning now to FIG. 6, shown therein is a diagram illustrating dynamic grouping workflow. According to FIG. 6, the dynamic grouping workflow may be initiated by checking whether the state is “Grouped”. If “yes”, the workflow can then check to see if the proximity to other riders is greater than a certain distance. If “no”, the workflow, can then revert back to the “Grouped” state. If “yes”, the workflow determines that the system may be close to out of range (or actually out of range). In such cases, a warning such as a “speed up” light may start flashing to alert the rider.

In some cases, as shown in FIG. 6, the workflow may perform a further check for proximity to other riders greater than a certain distance. If “no”, the workflow can revert back to the “Grouped” state again. If “Yes”, the workflow can determines that the system is in an “out of range” state and be placed into a “Soft Kicked” mode.

In some cases, as shown in FIG. 6, in a “Soft Kicked” mode, the number display may drop accordingly for all group members (i.e., “1” for the person that has just been soft kicked). Further, the number display may flash multiple times to indicate that the number of people in the group has changed, and in some cases the “Speed Up” light may continue to flash until the device is back in range.

In some cases, as shown in FIG. 6, the workflow can checks to determine whether the state comes back within range. If “no”, the workflow returns back to “Soft Kicked” mode. If “Yes”, the workflow returns to “Grouped” mode and can for example turn off the “Speed Up” light.

According to some further embodiments of the disclosure, when in “out of range”, certain implementations of the workflow may or may not have a device truly out of range. In particular, in some cases a buffer may be implemented for example in case the user presses the Stop/Help call button to go back into range.

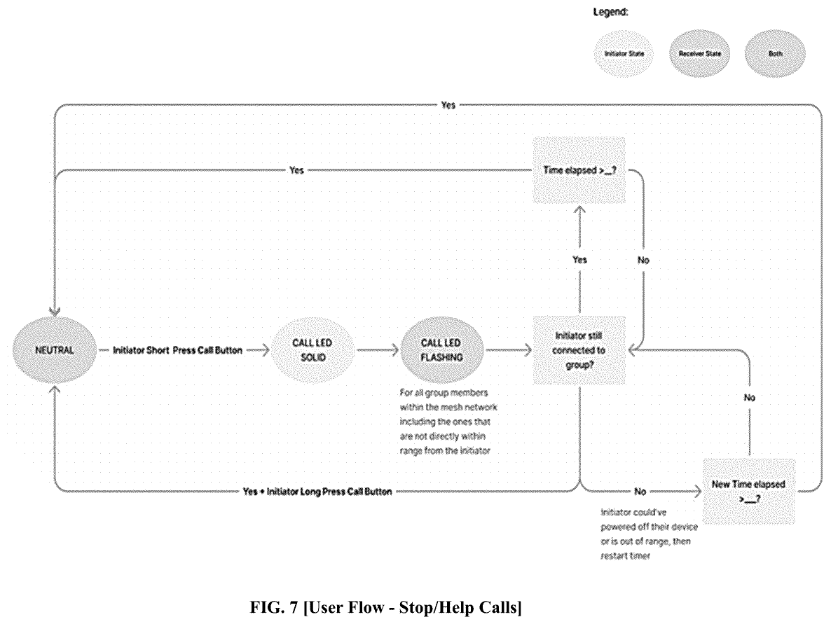

Turning now to FIG. 7, illustrated therein a diagram illustrating a workflow for Stop/Help calls. According to FIG. 7, the workflow can initiate with the workflow in “Neutral” mode. The rider can initiate a Stop/Help call by short pressing the call button where the call LED is solid light then the call LED reverts to flashing. The flashing call LED is shown to all group members within the mesh network including ones that are not directly within range from the initiator.

According to FIG. 7, the next step in the workflow is to determine whether the initiator is still connected to the group. If “Yes”, the workflow can then determines whether there is a timeout (i.e., time elapsed). If “no”, the workflow can then revert back to previous state. If “yes” (or time has elapsed or timeout), the workflow returns to “Neutral” mode. Furthermore, if “Yes” and a long press call button is selected by the initiator, the workflow can also revert back to “Neural” mode.

In some cases, as shown in FIG. 7, if the decision for the initiator still connected to the group is “no”, the workflow determines whether the new time has elapsed (or new timeout). For example, the initiator could have powered off their device or is out of range, then restart the timer. If the response is “no”, the workflow can revert back to the previous state.

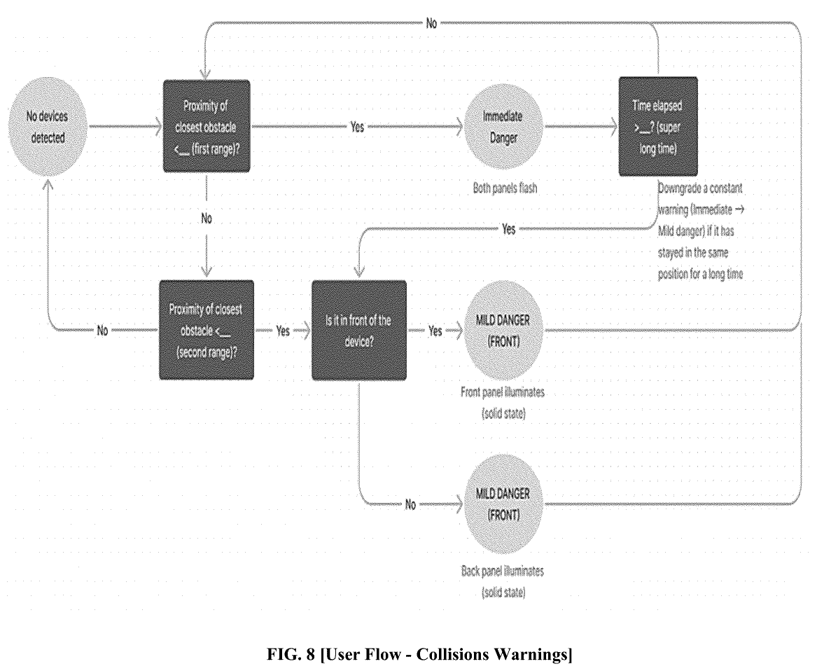

Turning now to FIG. 8, shown therein is a diagram illustrating collision warning workflow. According to FIG. 8, the workflow initiates with the state “No devices detected”. The workflow then checks whether the proximity of the closest obstacle is less than a first range. If the response is “No”, the workflow then checks whether the proximity of the closest obstacle is less than a second range. If “No” again, the workflow revert back to “No devices detected” state.

In some cases, as shown in FIG. 8, at the check at the first range, if the response is “Yes”, the workflow determines that the vehicle may be in “Immediate danger”. In such cases, both display panels may flash. Next, the workflow checks for a further timeout whether a certain amount of time has elapsed (i.e., a super long timeout). If “No”, the workflow revert back to the check for the first range. If “Yes”, the workflow checks to determine whether there is an object in front of the device. Further, the workflow downgrades to a constant warning (immediate to mild danger) if it has stayed in the same position for a long time (as this generally indicates that the detected object is stationary, such as a parked snowmobile).

In some cases, as shown in FIG. 8, at the workflow step of determining whether an object is in front of the device is “Yes”, mild danger in front may be determined. In such cases, the front panel may illuminate for example as a solid light or another state. Furthermore, if the response (whether object is in front of the device) is “No”, mild danger in back may be determined and the back panel may illuminate as a solid light or another state. The next step from both “Yes” and “No” response is to revert the workflow to check for first range.

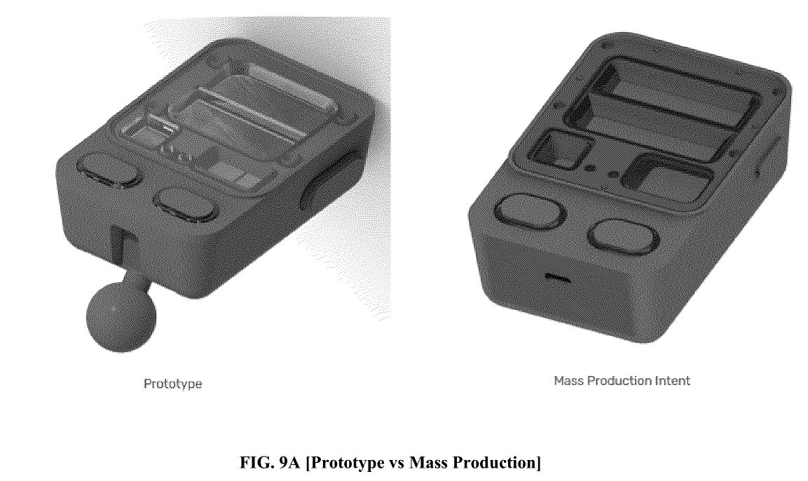

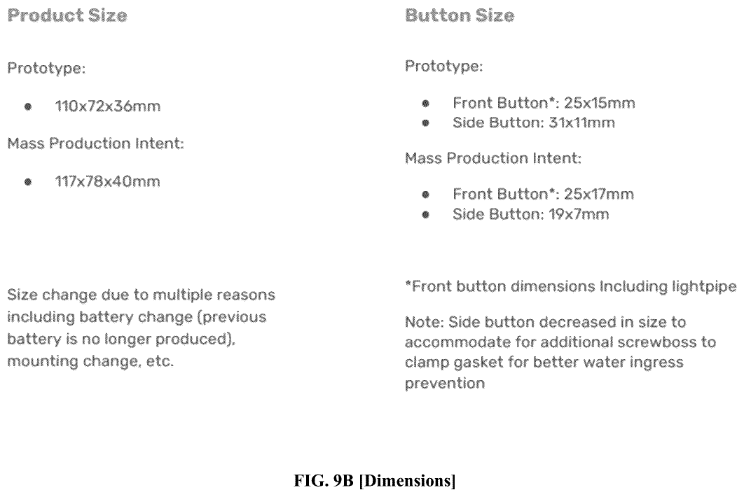

Turning now to FIG. 9A, illustrated therein is a perspective view of prototype device (on the left) and a mass production unit (on the right). According to FIG. 9A, the prototype unit (i.e., unit on left) shows the display panels, a USB-cutout slot and a ball hinge for mounting to the vehicle. According to FIG. 9B, the mass production until shows the display panels and a USB-cutout slot.

FIG. 9B is a table of the dimensions of prototype and mass production unit. According to FIG. 9B, dimensions of the prototype and mass production unit are 110 mm×72 mm×36 mm and 117 mm×78 mm×40 mm, respectively. The size difference is due to multiple reasons including battery changes, mounting changes and aesthetic design changes.

According to FIG. 9B, the button sizes for the prototype unit are 25 mm×15 mm for the front buttons and 31 mm×11 mm for the side button. For the mass production unit, the front buttons are 25×17 mm and the side buttons are 19×17 mm. The front button dimensions include light pipes. Further, the dimensions of the side button of the mass production units are decreased in size to accommodate additional screwbosses to clamp a gasket for better water ingress prevention.

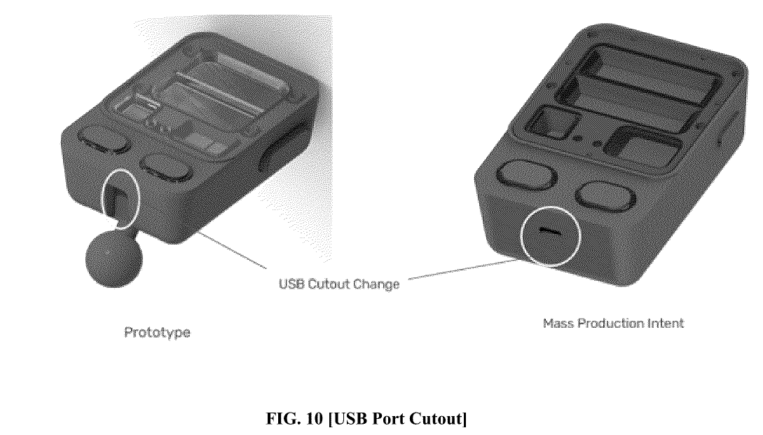

Turning now to FIG. 10, illustrated therein is a perspective view of the USB port cut-out of a prototype and mass production unit. According to FIG. 10, the USB of the mass production unit is no longer recessed. The USB-C port itself is splash proof, but it has been designed to over-mold around the opening or include a USB cover separately with the final product to further prevent water ingression around the opening.

Turning now to FIGS. 11A and 11B, illustrated therein are perspective views of the mounting interface for a prototype and mass production unit. According to FIG. 11A, the mounting interface is changed to accommodate a QuadLock mounting plate in order to keep the QuadLock mounting plate flush to bottom of device when attached, whereby the device thickness is increased. Furthermore, the same mounting interface can be used later on to develop other accessories including custom mounting options

According to FIG. 11B, two additional screwbosses are added to the device for gasket clamping and help prevent water ingression. The screwbosses will be visible from the back of the device. The remaining screwbosses are covered by the lens.

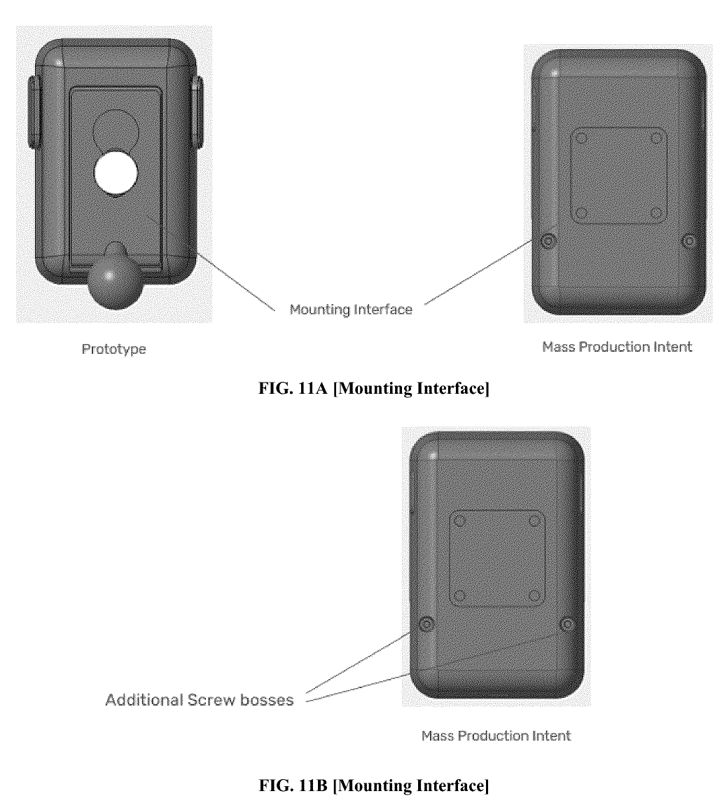

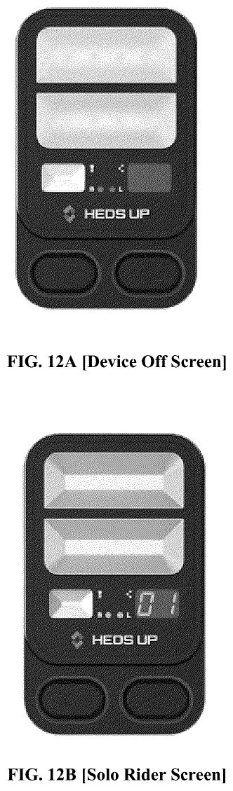

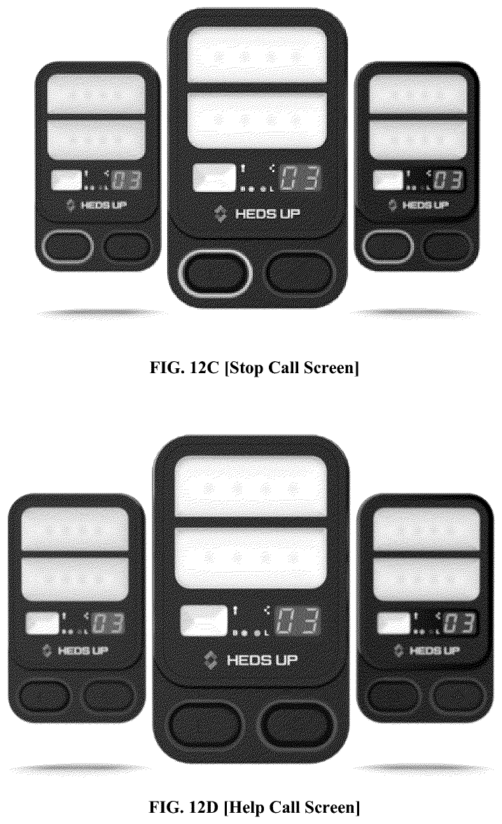

Turning now to FIGS. 12A to 12D, illustrated therein are diagrams illustrating different screens on the vehicle proximity and alert apparatus. FIG. 12A illustrates a diagram of the device off screen where all the panels are off.

FIG. 12B illustrates a solo rider screen where indicator for 1 rider is shown (i.e., “01”).

FIG. 12C illustrates a diagram of a stop call screen where all connected devices in the group will receive the stop request (i.e., bottom left button illuminated in yellow).

Finally, FIG. 12D illustrates a diagram of a help call screen wherein the right bottom button is illuminated in red to indicate a help request by a party in the group.

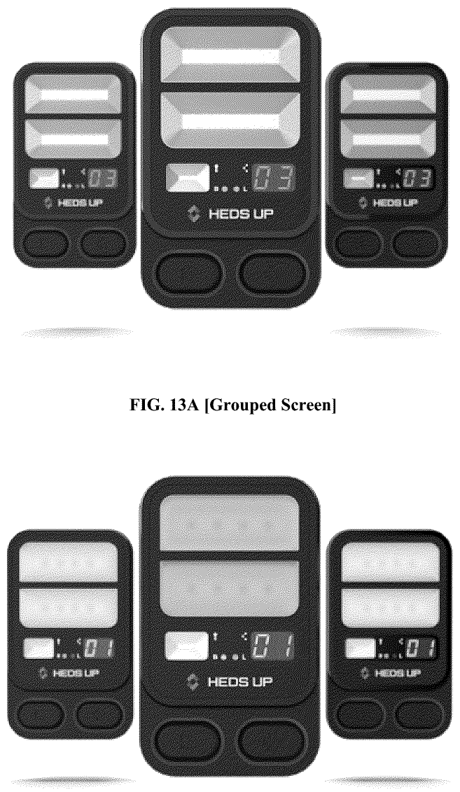

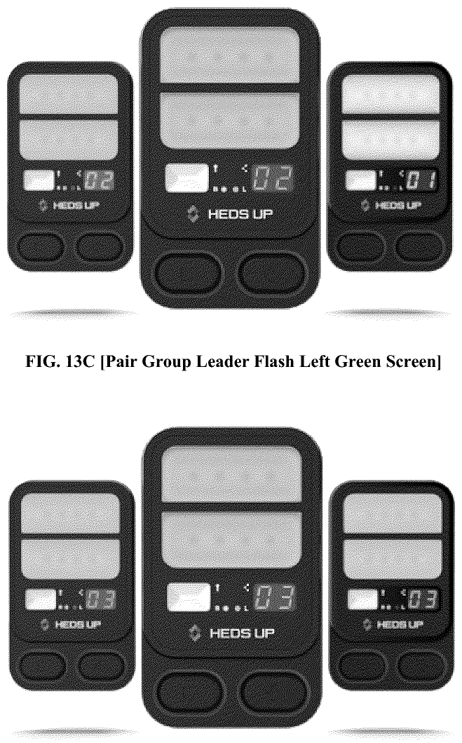

Turning now to FIGS. 13A to 13D, shown therein are diagrams illustrating different grouped screens on the vehicle proximity and alert apparatus.

FIG. 13A illustrates a diagram of a grouped screen.

FIG. 13B illustrates a diagram of a pair group leader flash screen where the top two panels of the leader device (i.e., middle device) turns green.

FIG. 13C illustrates a diagram of a pair group leader flash left screen where both the top two panels of the leader device (i.e., middle device) and left device turns green.

Finally, FIG. 13D illustrates a diagram of a pair group leader flash left green and right green screen whereby the top two panels of all three devices are green.

### Future Development

According to further embodiments of the disclosure, further implementations of the design may incorporate the following features:
Modify roundings, symmetry details and front buttons to achieve a more “refined” look in the final product.
The edges of 7-segment display and speed light may not be vertically in-line with the collision panels
In some cases, the leader and battery status LED placements to be more vertically aligned so that the speed and 7-segment display lights can move towards the center. This may have a big impact on printed circuit board (PCB) release deadline and should be re-evaluated in the next revision.
In some embodiments, collision panels can be expanded length-wise to achieve the same results without moving the LED placements.
In some embodiments, the side buttons of the device may be raised more to help users with locating them.

According to the disclosure, the current implementation of the device/apparatus can be used in off-road vehicles or snowmobiles. Future implementations of the disclosure can be used in logging trucks and marine vehicles (e.g., boats, jetskis, etc.).

### General Considerations

The functions described herein may be stored as one or more instructions on a processor-readable or computer-readable medium. The term “computer-readable medium” refers to any available medium that can be accessed by a computer or processor. By way of example, and not limitation, such a medium may comprise RAM, ROM, EEPROM, flash memory, CD-ROM or other optical disk storage, magnetic disk storage or other magnetic storage devices, or any other medium that can be used to store desired program code in the form of instructions or data structures and that can be accessed by a computer. It should be noted that a computer-readable medium may be tangible and non-transitory. As used herein, the term “code” may refer to software, instructions, code or data that is/are executable by a computing device or processor. A “module” can be considered as a processor executing computer-readable code.

A processor as described herein can be a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein.

A general-purpose processor can be a microprocessor, but in the alternative, the processor can be a controller, or microcontroller, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. In some embodiments, a processor can be a graphics processing unit (GPU). The parallel processing capabilities of GPUs can reduce the amount of time for training and using neural networks (and other machine learning models) compared to central processing units (CPUs). In some embodiments, a processor can be an ASIC including dedicated machine learning circuitry custom-build for one or both of model training and model inference.

The disclosed or illustrated tasks can be distributed across multiple processors or computing devices of a computer system, including computing devices that are geographically distributed. The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.” While the foregoing written description of the system enables one of ordinary skill to make and use what is considered presently to be the best mode thereof, those of ordinary skill will understand and appreciate the existence of variations, combinations, and equivalents of the specific embodiment, method, and examples herein. The system should therefore not be limited by the above-described embodiment, method, and examples, but by all embodiments and methods within the scope and spirit of the system. Thus, the present disclosure is not intended to be limited to the implementations shown herein but is to be accorded the widest scope consistent with the principles and novel features disclosed herein.

It will be appreciated that numerous specific details are set forth in order to provide a thorough understanding of the example embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description and the drawings are not to be considered as limiting the scope of the embodiments described herein in any way, but rather as merely describing the implementation of the various embodiments described herein.

The embodiments of the systems and methods described herein may be implemented in hardware or software, or a combination of both. These embodiments may be implemented in computer programs executing on programmable computers, each computer including at least one processor, a data storage system (including volatile memory or non-volatile memory or other data storage elements or a combination thereof), and at least one communication interface. For example and without limitation, the programmable computers (referred to herein as computing devices) may be a server, network appliance, embedded device, computer expansion module, a personal computer, laptop, personal data assistant, cellular telephone, smart-phone device, tablet computer, a wireless device or any other computing device capable of being configured to carry out the methods described herein.

In some embodiments, the communication interface may be a network communication interface. In embodiments in which elements are combined, the communication interface may be a software communication interface, such as those for inter-process communication (IPC). In still other embodiments, there may be a combination of communication interfaces implemented as hardware, software, and combination thereof.

Program code may be applied to input data to perform the functions described herein and to generate output information. The output information is applied to one or more output devices, in known fashion.

Each program may be implemented in a high level procedural or object oriented programming and/or scripting language, or both, to communicate with a computer system. However, the programs may be implemented in assembly or machine language, if desired. In any case, the language may be a compiled or interpreted language. Each such computer program may be stored on a storage media or a device (e.g. ROM, magnetic disk, optical disc) readable by a general or special purpose programmable computer, for configuring and operating the computer when the storage media or device is read by the computer to perform the procedures described herein. Embodiments of the system may also be considered to be implemented as a non-transitory computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

Various embodiments have been described herein by way of example only. Various modification and variations may be made to these example embodiments without departing from the spirit and scope of the invention, which is limited only by the appended claims. Also, in the various user interfaces illustrated in the drawings, it will be understood that the illustrated user interface text and controls are provided as examples only and are not meant to be limiting. Other suitable user interface elements may be possible.

1. A vehicle proximity and alert system for use with off-road vehicles, comprising:
a. a plurality of devices operable for communication with each other, each device secured to a different off-road vehicles;
b. a processor operable to determine whether at least some of the plurality of devices are connected together, and if so to define a group;
c. at least one sensor operable for determining the proximity and speed of the devices associated with the group;
d. the at least one sensor operable to identify a collision risk and alert at least one member of the group accordingly in response to the identified collision risk.

2. The vehicle proximity and alert system of claim 1, wherein a lead user of the system can add and remove members of the group.

3. The vehicle proximity and alert system of claim 1, wherein the members of the group can leave the group by physically exceeding a distance from the other members of the group for a particular period of time.

4. The vehicle proximity and alert system of claim 3, wherein when a member exits the group, one or more other members of the group will receive an indication regarding the exiting group member.

5. The vehicle proximity and alert system of claim 1, wherein each member of the group can press a request button to ask the group to stop or slow down.

6. The vehicle proximity and alert system of claim 1, wherein plurality of devices are in communication using at least one of Bluetooth low energy (BLE), LoRaWAN (i.e., LoRa) technologies, and global positioning system technologies.

7. The vehicle proximity and alert system of claim 1, further adapted to detect other devices outside of the group and use acquired information about those other devices to calculate proximity of their associated vehicles.

8. The vehicle proximity and alert system of claim 1, wherein, when a potential collision risk is determined, the processor checks whether the proximity of the collision risk is less than a first range, and if so triggers a first critical alert.

9. The vehicle proximity and alert system of claim 8, wherein, if the proximity of the collision risk is not less than the first range, then the processor checks whether the proximity of the collision risk is less than a second range, and if so triggers a secondary alert.

10. The vehicle proximity and alert system of claim 9, wherein, if the proximity of the collision risk is not less than the second range, then the processor triggers a further alert.

11. The vehicle proximity and alert system of claim 1, wherein each device in a group indicates a number of members within that group.

12. The vehicle proximity and alert system of claim 1, wherein members may be added to the group by associating their devices together.

13. The vehicle proximity and alert system of claim 1, wherein when a member of a group exceeds a particular range away from the remaining group members, that member is determined to have left the group.

14. The vehicle proximity and alert system of claim 13, wherein when that member returns within a particular range of the remaining group members, that member is determined to have rejoined the group.
